(19) United States
(12) Patent Application Publication
(10) Pub. No.: US 2026/0078614 A1
(43) Pub. Date: Mar. 19, 2026

(54) VEHICLE DOOR LATCH EQUIPMENT

(71) Applicant: Minebea AccessSolutions France, Alfortville (FR)

(72) Inventors: François DEBROUCKE, Alfortville (FR); Robin DUVAUCHELLE, Alfortville (FR); Aurélie SZALAI, Alfortville (FR)

(73) Assignee: Minebea AccessSolutions France, Alfortville (FR)

(21) Appl. No.: 19/330,912

(22) Filed: Sep. 17, 2025

(30) Foreign Application Priority Data
Sep. 17, 2024 (EP) 24315426

(51) Int. Cl. E05B 81/06; E05B 79/20; E05B 83/36

(52) U.S. Cl. CPC E05B 81/06; E05B 79/20; E05B 83/36

(57) ABSTRACT

Vehicle door latch equipment includes a latch mechanism including a claw for engaging with a striker to lock the door and a closing assistance actuator linked to the claw for rotating the claw to bring the latch mechanism in a closed position. The latch mechanism and the closing assistance actuator can be assembled to a door panel. The latch mechanism and the closing assistance actuator are pre-assembled together by a damping element in order to ease their assembly to the door panel.

### TECHNICAL FIELD

The present invention relates to the field of vehicle door latches to ensure the closing of vehicle doors and in particular to latches comprising a closing electrical assistance.

### BACKGROUND OF THE INVENTION

The present invention refers to a vehicle door latch equipment comprising a vehicle door latch and a closing assistance actuator configured to bring the vehicle door latch in a closed position to ease the closing of the door.

The closing electrical assistance appears to be an option which is mostly used in high-end cars. It is therefore advantageous that the closing assistance actuator be external to the vehicle door latch so that a latch model may be used with or without a closing assistance actuator depending on the request of the car manufacturer which enables limiting the number of references of the vehicle door latches.

However, having two separate devices leads to a more complicated assembly on the door panel.

It is therefore a goal of the present invention to provide a vehicle door latch equipment with a closing electrical assistance that eases the assembly of the vehicle door latch equipment on the door panel.

### SUMMARY OF THE INVENTION

The present invention refers to a vehicle door latch equipment comprising:
a latch mechanism comprising a claw configured for engaging with a striker to lock the door,
a closing assistance actuator linked to the claw and configured for rotating the claw to bring the latch mechanism in a closed position,
   the latch mechanism and the closing assistance actuator being configured to be assembled to a door panel,
   wherein the latch mechanism and the closing assistance actuator are pre-assembled together by a damping element in order to ease their assembly to the door panel.

According to another aspect of the present invention, the closing assistance actuator is linked to the claw by a Bowden cable.

According to another aspect of the present invention, the damping element (15) is made of elastomer.

According to another aspect of the present invention, the damping element is made of rubber.

According to another aspect of the present invention, the damping material has a hardness comprised between 50 to 80 Shore A.

According to another aspect of the present invention, the latch mechanism and the closing assistance actuator are pre-assembled together by a first pad and a second pad.

According to another aspect of the present invention, the first pad and the second pad have a cross section with a bone shape to provide two cylindrical ends configured to be received in complementary shells of the latch mechanism and the closing assistance actuator.

According to another aspect of the present invention, the latch mechanism and the closing assistance actuator are configured to be assembled to a door panel by at least two screws, for example three screws.

### BRIEF DESCRIPTION OF THE DRAWINGS

FIG. 1 is a perspective view of a vehicle door latch equipment according to an embodiment of the present invention;

FIG. 2 is an enlarged view of the link between the latch mechanism and the closing assistance actuator;

FIG. 3 is a perspective view of the linking pads used for linking the latch mechanism and the closing assistance actuator;

### DETAILED DESCRIPTION OF THE INVENTION

The following achievements are examples. Although, the specification refers to one or several embodiments, it does not imply that each reference refers to the same embodiment or that the features apply only to a single embodiment. Simple features of different embodiments can also be combined to provide other embodiments.

The present invention refers to a vehicle door latch equipment 1 configured to ensure the closing of a vehicle door, in particular a side door or a trunk lid.

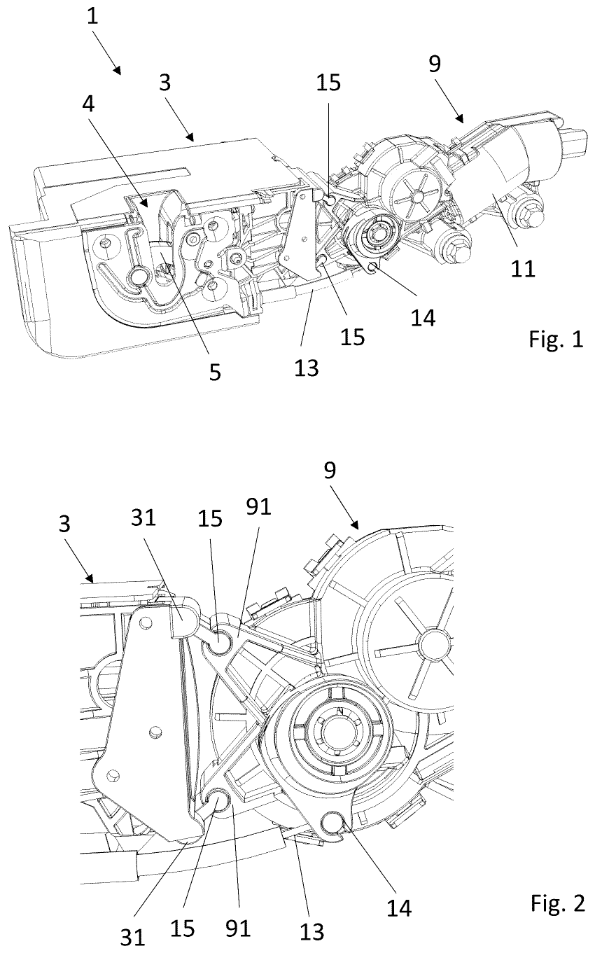

FIG. 1 represents an example of such vehicle door latch equipment 1.

The vehicle door latch equipment 1 comprises a latch mechanism 3 with a recess 4 comprising a claw 5 configured for engaging with a striker (not represented) set to the vehicle body to lock the door. The claw 5 is configured to rotate between an opened position of the latch mechanism 3 wherein the striker may be introduced or removed from the claw 5 and a closed position of the latch mechanism 3 wherein the striker is retained within the recess 4 by the claw 5. The latch mechanism 3 is configured to be assembled to a door panel. The latch mechanism 3 may be assembled to the door panel by at least two screws, for example three screws.

The vehicle door latch equipment 1 also comprises a closing assistance actuator 9 linked to the claw 5 and configured for rotating the claw 5 to bring the latch mechanism 3 in a closed position. The closing assistance actuator 9 may comprise an electrical motor 11 and may be linked to the claw 5 by a Bowden cable 13. The electrical motor 11 may be configured to rotate a crank 14 that pulls on the Bowden cable 13 that make the claw 5 rotates towards its closing position. The closing assistance actuator 9 is configured to be assembled to the door panel. The closing assistance actuator 9 may be assembled to the door panel by at least two screws, for example three screws.

Furthermore, the latch mechanism 3 and the closing assistance actuator 9 are linked together to provide a pre-assembly. The latch mechanism 3 and the closing assistance actuator 9 are linked together by a damping material such as an elastomer or rubber in order to prevent a hyperstatic assembly when both the latch mechanism 3 and the closing assistance actuator 9 are assembled to the door panel. Other material providing a damping effect preventing a hyperstatic assembly may also be used. The damping material may have a hardness comprised between 50 to 80 Shore A. The link may be made of at least one pad 15. In the present example, two pads 15 are used to link the latch mechanism 3 and the closing assistance actuator 9 as more visible in the enlarged view of FIG. 2. The number and the size of the pads 15 are chosen according to the mechanical features of the damping material in order for the pre-assembly to enable a positioning of the latch mechanism 3 by moving the closing assistance actuator 9 and conversely.

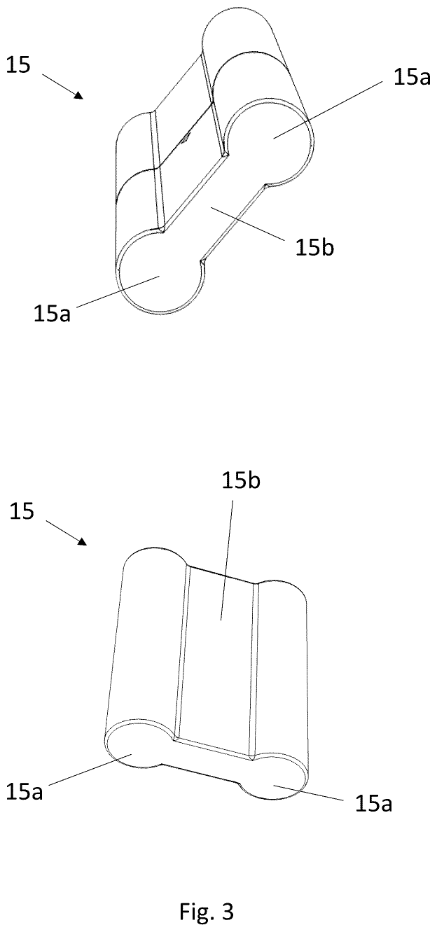

FIG. 3 represents a perspective of the pads 15. The pads 15 may have a cross-section with the shape of a bone with two cylindrical ends 15a linked by a thinner central part 15b.

The latch mechanism 3 may comprise a casing, for example a plastic casing, with shells 31 having a complementary shape with the end 15a of the pads 15 so that the end 15a of the pads 15 may be slid within the shell 31. Accordingly, the closing assistance actuator 9 may have a casing, for example a plastic casing, with shells 91 having a complementary shape with the end 15a of the pads 15 so that the end 15a of the pad 15 may be slid within the shell 91.

Thus, the assembly of the vehicle door latch equipment 1 requires only one positioning step of the vehicle door latch equipment 1 in front of the door panel to assemble one of the latch mechanism 3 or the closing assistance actuator 9, for example by screwing three screws associated with the casing of the latch mechanism 3 or the closing assistance actuator 9. The pre-assembly between the latch mechanism 3 and the closing assistance actuator 9 enables therefore the positioning of the other part (among the latch mechanism 3 and the closing assistance actuator 9) so that the closing assistance actuator 9 or the latch mechanism 3 may then be assembled to the door panel, for example by screwing three screws associated with its casing, without requiring another positioning step. For example, if the latch mechanism 3 is first assembled to the door panel, the assembly of the closing assistance actuator 9 only requires to screw the different screws associated with the casing of the closing assistance actuator 9 as the closing assistance actuator 9 is already rightly positioned (the screws are located in front of the fixing holes of the door panel).

Furthermore, due to the use of a damping material to link the latch mechanism 3 and the closing assistance actuator 9, the assembly of the latch mechanism 3 and the closing assistance actuator 9 to the door panel does not introduce any additional constraint that would lead to a hyperstatic assembly for the vehicle door latch equipment 1. The damper 15 deforms to absorb hyperstatic alignments.

1-8. (canceled)

9. Vehicle door latch equipment, comprising:
a latch mechanism comprising a claw configured to engage with a striker to lock a door; and
a closing assistance actuator linked to the claw and configured to rotate the claw to bring the latch mechanism in a closed position,
the latch mechanism and the closing assistance actuator being configured to be assembled to a door panel,
wherein the latch mechanism and the closing assistance actuator are pre-assembled together by a damping element in order to ease their assembly to the door panel.

10. The vehicle door latch equipment in accordance with claim 9, wherein the closing assistance actuator is linked to the claw by a Bowden cable.

11. The vehicle door latch equipment in accordance with claim 9, wherein the damping element is made of elastomer.

12. The vehicle door latch equipment in accordance with claim 11, wherein the damping element is made of rubber.

13. The vehicle door latch equipment in accordance with claim 9, wherein a damping material of the damping element has a hardness comprised between 50 to 80 Shore A.

14. The vehicle door latch equipment in accordance with claim 9, wherein the latch mechanism and the closing assistance actuator are pre-assembled together by a first pad and a second pad.

15. The vehicle door latch equipment in accordance with claim 14, wherein the first pad and the second pad have a cross section with a bone shape to provide two cylindrical ends configured to be received in complementary shells of the latch mechanism and the closing assistance actuator.

16. The vehicle door latch equipment in accordance with claim 9, wherein the latch mechanism and the closing assistance actuator are configured to be assembled to the door panel by at least two screws.
